(19) United States
(12) Patent Application Publication
(10) Pub. No.: US 2019/0271175 A1
(43) Pub. Date: Sep. 5, 2019

(54) DRIVING FORCE TRANSMISSION MECHANISM AND ELECTRIC LOCK USING SAME

(71) Applicant: NTN CORPORATION, Osaka (JP)

(72) Inventor: Shoji ITOMI, Mie (JP)

(73) Assignee: NTN CORPORATION, Osaka (JP)

(21) Appl. No.: 16/334,056

(22) PCT Filed: Sep. 19, 2017
(86) PCT No.: PCT/JP2017/033666

§ 371 Date: Mar. 18, 2019

(30) Foreign Application Priority Data
Sep. 21, 2016 (JP) 2016-184008

(51) Int. Cl. E05B 47/06; H01H 9/28; E05B 47/00

(52) U.S. Cl. CPC E05B 47/0665; E05B 17/0029; E05B 47/0001; H01H 9/283

(57) ABSTRACT

A driving force transmission mechanism is provided which includes an input switching clutch configured to selectively transmit, to the output shaft (output member), either one of the rotationally driving force applied to the electrically driven input gear (first input member) and the rotationally driving force applied to the manually driven input shaft (second input shaft). A speed reducer having a simple structure and having no self-locking function is attached to the input side of the electrically driven input gear so that the rotation torque necessary to rotate the electrically driven input gear through the input switching clutch from the manually driven input shaft is larger than the rotation torque necessary to rotate the output shaft through the input switching clutch from the manually driven input shaft.

### TECHNICAL FIELD

The present invention relates to a driving force transmission mechanism including an input switching clutch which enables an output member to be rotationally driven by both a first input member and a second input member, and an electric lock in which the driving force transmission mechanism is used.

### BACKGROUND ART

In many product fields, machines or devices which used to be manually activated are starting to be electrically activated these days. Such electrically activated machines or devices are, though depending on functions thereof, frequently required to be manually activated in case of power outage or battery exhaustion. For example, electric locks capable of being locked and unlocked without using a key are starting to be widely used at entrance doors. However, such electric locks also need to be locked and unlocked with a conventional method, i.e., with a key in case of an emergency such as power outage.

As such an electric lock, an electric lock is known which includes a first input member configured to be rotationally driven by the electric driving force of a motor; a second input member configured to be rotationally driven by the manual driving force of a key or a thumb turn; an output member configured to move a dead bolt in the protruding or retracting direction; and an input switching clutch configured to selectively transmit, to the output member, either one of the driving force applied to the first input member, and the driving force applied to the second input member, and which (electric lock) can be locked and unlocked both electrically and manually (e.g., see the below-identified Patent Document 1).

### PRIOR ART DOCUMENTS

### Patent Documents

Patent document 1: Japanese Unexamined Patent Application Publication No. 2016-108928

### SUMMARY OF THE INVENTION

### Problems to be Solved by the Invention

The electric lock proposed in Patent Document 1 includes a reverse input blocking mechanism mounted between the motor and the first input member, and configured to allow the rotationally driving force of the motor to be transmitted to the first input member, and to lock up when reverse input torque is applied to the first input member, thereby making the first input member stationary. Due to this structure, though, when the second input member is rotationally driven, reverse input torque is applied from the input switching clutch to the first input member, the first input member is kept stationary, and does not rotate together. Therefore, it is possible to operate the key and the thumb turn with a light force so as to lock and unlock the electric lock.

However, since such a reverse input blocking mechanism comprises a worm gear mechanism having a self-locking function; a reduction mechanism having a high reduction ratio; or a reverse input blocking clutch configured to transmit input torque to the output side of the electric lock, and to lock up when reverse input torque is applied to the output side, thereby blocking the transmission of the reverse input torque, the electric lock including such a reverse input blocking mechanism entirely has a complicated structure.

Such a problem is seen not only in electric locks but also in other devices including a driving force transmission mechanism which enables, due to the action of the input switching clutch, the output member to be rotationally driven by both the first input member and the second input member.

It is an object of the present invention to provide (i) a driving force transmission mechanism which enables the output member to be rotationally driven by both the first input member and the second input member, and which can prevent, with a simple structure, the first input member from rotating together when the output member is driven by the second input member, and (ii) an electric lock in which the driving force transmission mechanism is used.

### Means for Solving the Problems

In order to achieve the above object, the present invention provides a driving force transmission mechanism comprising: a first input member; a second input member; an output member; and an input switching clutch configured to selectively transmit, to the output member, either one of a first rotationally driving force applied to the first input member and a second rotationally driving force applied to the second input member, wherein rotation torque necessary to rotate the first input member through the input switching clutch from the second input member is set to be larger than rotation torque necessary to rotate the output member through the input switching clutch from the second input member.

With this arrangement, it is possible to rotationally drive the output member by both the first input member and the second input member, and to prevent the first input member from rotating together when the output member is driven by the second input member, without mounting a reverse input blocking mechanism having a complicated structure, such as a worm gear mechanism, a reduction mechanism having a high reduction ratio, or a reverse input blocking clutch.

Specifically, for example, the driving force transmission mechanism may further comprise, on an input side of the first input member, a speed reducer having no self-locking function. Since the speed reducer is required to simply increase, due to torque loss, the rotation torque necessary to rotate the first input member, the speed reducer is simpler in structure than conventional ones having a self-locking function and a high reduction ratio.

Alternatively, the driving force transmission mechanism may further comprise a braking force applying means for applying a braking force to a braking force receiving member comprising the first input member. Alternatively, the driving force transmission mechanism may be a mechanism wherein the input switching clutch comprises: an outer ring having a cylindrical inner peripheral surface, and coupled to the first input member such that rotation can be transmitted between the outer ring and the first input member; an inner ring disposed radially inwardly of the outer ring, and configured to rotate about a center axis of the second input member together with the output member, the inner ring having, on an outer peripheral surface of the inner ring, a plurality of cam surfaces arranged circumferentially such that a wedge-shaped space is defined between the inner peripheral cylindrical surface of the outer ring and each of the cam surfaces of the inner ring, the wedge-shaped space gradually narrowing toward respective circumferential ends thereof to define narrow portions at the respective circumferential ends; locking engagement elements and a spring disposed in each of the wedge-shaped spaces such that the spring wedges the locking engagement elements into the respective narrow portions of the wedge-shaped space; an unlocking piece having pillars, and coupled to the second input member such that rotation can be transmitted between the unlocking piece and the second input member, each pair of the pillars being inserted, respectively, in the circumferential ends of the wedge-shaped space, or the pillars being each inserted between a corresponding adjacent pair of the wedge-shaped spaces; and a torque transmission means disposed between the second input member and the inner ring, and configured to transmit rotation of the second input member to the inner ring with a slight angular delay, wherein the input switching clutch is configured such that, when the first rotationally driving force is applied to the first input member, the outer ring and the inner ring are locked together through one of the locking engagement elements in each of the wedge-shaped spaces, thereby transmitting the first rotationally driving force to the inner race and the output member; and such that, when the second rotationally driving force is applied to the second input member, and the second input member rotates, the outer ring and the inner ring are unlocked from each other, thereby transmitting the second rotationally driving force to the inner ring and the output member, and wherein the driving force transmission mechanism further comprises a braking force applying means for applying a braking force to a braking force receiving member comprising the outer ring of the input switching clutch.

The braking force applying means may comprise an elastic member mounted, while elastically deformed, between a fixed member and the braking force receiving member.

The present invention also provides an electric lock comprising: the above driving force transmission mechanism; a motor configured to rotationally drive the first input member; one of a key and a thumb turn configured to rotationally drive the second input member when a manual driving force is applied to the one of the key and the thumb turn; and a dead bolt configured to move in one of a protruding direction and a retracting direction when the output member rotates.

### Effects of the Invention

Since, as described above, the driving force transmission mechanism of the present invention enables the output member to be rotationally driven by both the first input member and the second input member, and also can prevent, without using a reverse input blocking mechanism complicated in structure, the first input member from rotating together when the output member is driven by the second input member, the driving force transmission mechanism of the present invention can be designed relatively freely, and the entire structure thereof is simple, compared to conventional ones.

Since such a driving force transmission mechanism is mounted in the electric lock of the present invention, the electric lock of the present invention is simpler in structure than conventional ones, and can be manually locked and unlocked with a light force.

### BRIEF DESCRIPTION OF THE DRAWINGS

FIG. 1 is a vertical sectional front view of a driving force transmission mechanism according to a first embodiment of the present invention.

FIG. 2 is a sectional view taken along line II-II of FIG. 1.

FIGS. 3A and 3B are views each illustrating how an input switching clutch of FIG. 1 operates when a manual driving force is applied.

FIG. 4 is a vertical sectional front view of a driving force transmission mechanism according to a second embodiment of the present invention.

FIG. 5 is a vertical sectional front view of a driving force transmission mechanism according to a third embodiment of the present invention.

FIG. 6 is a vertical sectional front view of an electric lock in which a modified version of the driving force transmission mechanism of the first embodiment is mounted.

FIG. 7 is a sectional view taken along line VII-VII of FIG. 6.

### BEST MODE FOR CARRYING OUT THE INVENTION

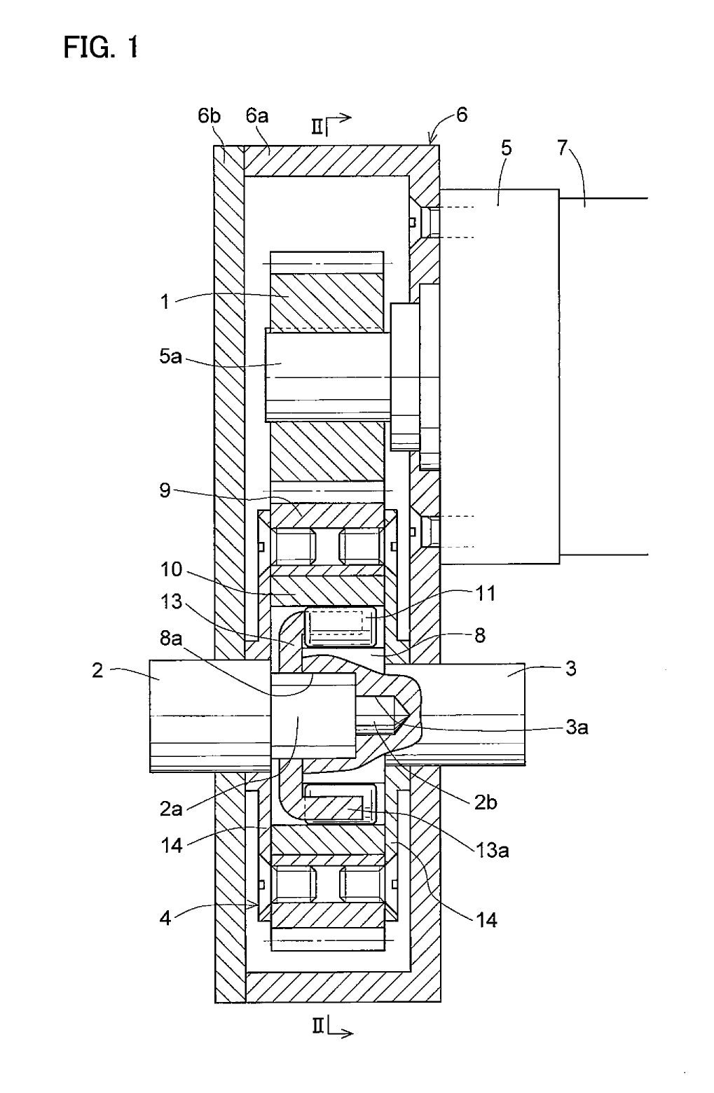

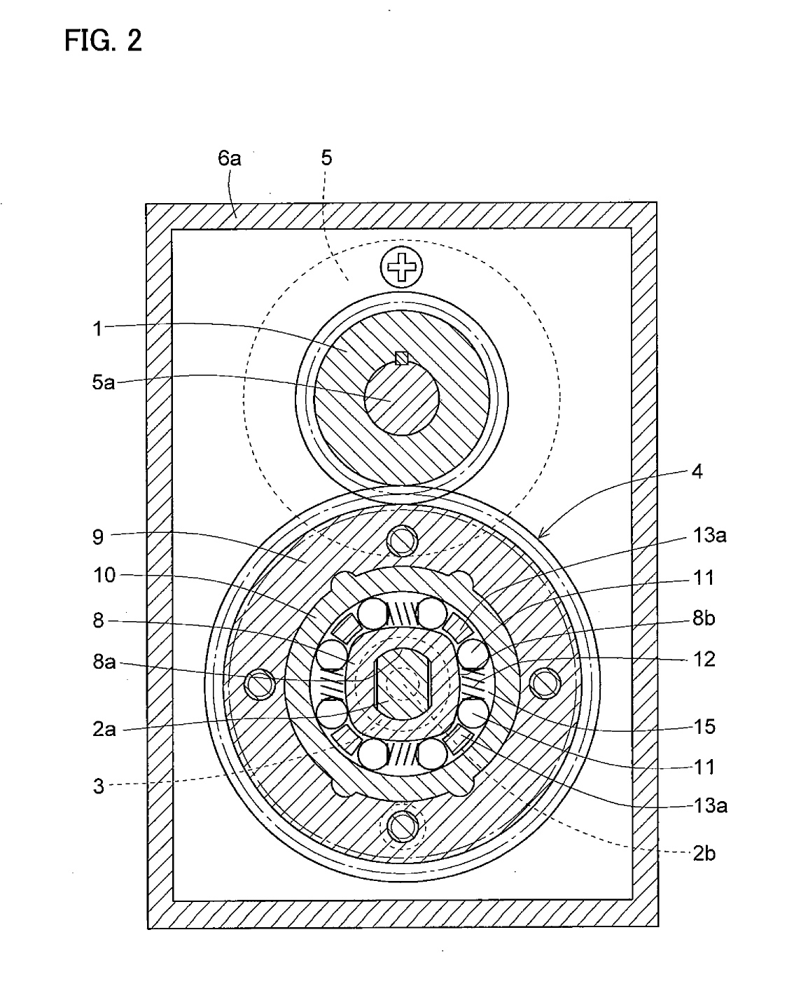

The embodiments of the present invention are described below with reference to the drawings. FIGS. 1 to 3 illustrate a driving force transmission mechanism according to the first embodiment of the present invention. As illustrated in FIGS. 1 and 2, this driving force transmission mechanism includes an electrically driven input gear 1 as a first input member; a manually driven input shaft 2 as a second input member; an output shaft 3 as an output member; an input switching clutch 4 configured to selectively transmit, to the output shaft 3, either one of the rotationally driving force electrically applied to the electrically driven input gear 1, and the rotationally driving force manually applied to the manually driven input shaft 2; and a speed reducer 5 disposed on the input side of the electrically driven input gear 1. The electrically driven input gear 1, the inner end portions of the manually driven input shaft 2 and the output shaft 3, and the input switching clutch 4 are received in a housing (fixed member) 6 which comprises a rectangular box portion 6a having an open side, and a lid portion 6b closing the open side of the box portion 6a. The speed reducer 5 has no self-locking function, and is a portion of a motor assembly including a motor 7 for driving the electrically driven input gear 1. The speed reducer 5 is fixed to the outer side surface of the housing 6, and includes, on the output side thereof, a small diameter portion 5a located within the housing 6 and fixedly keyed to the inner periphery of the electrically driven input gear 1.

The manually driven input shaft 2 includes a large diameter portion at the outer end thereof, and is rotatably supported by the housing 6 with the large diameter portion partially protruding beyond the housing 6. The manually driven input shaft 2 further includes an engagement portion 2a extending from the large diameter portion of the input shaft 2, and having two flat surfaces on the outer periphery of the engagement portion 2a; and a small diameter cylindrical portion 2b protruding from the inner end surface of the engagement portion 2a. The output shaft 3 is rotatably supported by the housing 6 with the outer end of the output shaft 3 protruding beyond the housing 6. As described later in detail, an inner ring 8 constituting a portion of the input switching clutch 4 is integrally connected to the inner end of the output shaft 3.

The distal end portion of the engagement portion 2a of the manually driven input shaft 2 is inserted into an engagement hole 8a in the center of the inner ring 8, with the small diameter cylindrical portion 2b of the input shaft 2 fitted, through the bottom of the engagement hole 8a, into a circular hole 3a in the output shaft 3, so that the manually driven input shaft 2, the output shaft 3, and the inner ring 8 are rotatable about a common axis. The engagement hole 8a of the inner ring 8 is substantially identical in sectional shape to the engagement portion 2a of the manually driven input shaft 2 such that, when the engagement portion 2a is inserted into the engagement hole 8a, a minute gap in the rotational direction is defined between the engagement portion 2a and the engagement hole 8a. This structure thus constitutes a torque transmission means for transmitting the rotation of the manually driven input shaft 2 to the inner ring 8 with a slight angular delay.

The input switching clutch 4 includes an intermediate gear 9 in mesh with the electrically driven input gear 1; an outer ring 10 fixedly fitted to the inner periphery of the intermediate gear 9; the above-mentioned inner ring 8, which is disposed radially inwardly of the outer ring 10; rollers (locking engagement elements) 11 and coil springs 12 that are both disposed between the inner peripheral surface of the outer ring 10 and the outer peripheral surface of the inner ring 8; and an unlocking piece 13 having pillars 13a each inserted at a position opposed to one of the coil springs 12 through the intervening roller 11. Side plates 14 are fixed by screws to the respective end surfaces of the intermediate gear 9 such that the manually driven input shaft 2 and the output shaft 3 extend through the respective side plates 14, and such that the axial ends of the space between the inner and outer races 8 and 10 are closed by the respective side plates 14.

The inner ring 8 has a plurality of cam surfaces 8b on its outer periphery such that a wedge-shaped space 15 gradually narrowing toward both circumferential ends thereof is defined between each cam surface 8b and a cylindrical inner peripheral surface of the outer ring 10. A pair of the rollers 11 and one of the coil springs 12 are disposed in each wedge-shaped space 15 with the coil spring 12 sandwiched between the pair of rollers 11 so as to wedge the pair of rollers 11 into the respective narrow circumferential end portions of the wedge-shaped space 15. Two of the pillars 13a of the unlocking piece 13 are located at the respective circumferential ends of each wedge-shaped space 15, or each pillar 13a is located between the corresponding adjacent pair of wedge-shaped spaces 15. The unlocking piece 13 is fixedly fitted to the outer periphery of the engagement portion 2a of the manually driven input shaft 2.

The input switching clutch 4 is configured such that, when a rotationally driving force is applied from the motor 7 to the outer ring 10 through the speed reducer 5 and the electrically driven input gear 1, the outer ring 10 and the inner ring 8 are locked together through the rollers 11 that are located forward in the rotational direction of the outer ring 10 (relative to the other rollers in the respective wedge-shaped spaces), and each being wedged, by the elastic force of the coil spring 12, into the narrow circumferential end portion of the wedge-shaped space 15 located forward in the rotational direction (these rollers are hereinafter referred to as the “rotationally forward rollers 11”), so that the rotationally driving force of the outer ring 10 is transmitted to the inner ring 8 and the output shaft 3. At this time, since the pillars 13a of the unlocking piece 13 are pushed by the rotationally forward rollers 11, the manually driven input shaft 2, to which the unlocking piece 13 is fixed, also rotates together.

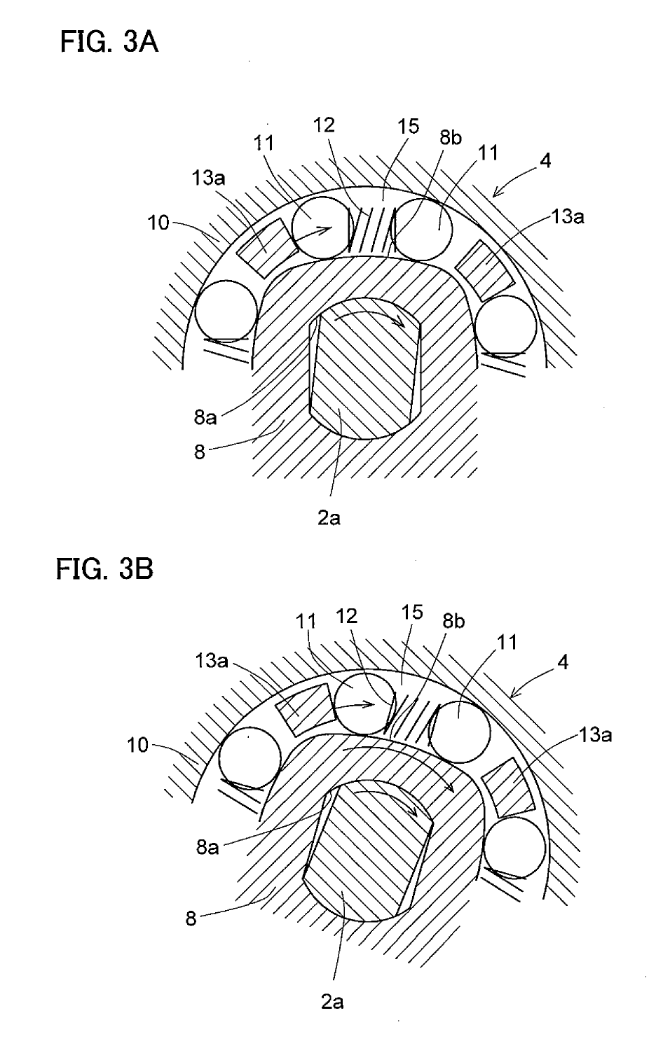

When a rotationally driving force is applied to the manually driven input shaft 2, first, as illustrated in FIG. 3A, with the outer ring 10 kept stationary due to the below-described mechanism, the pillars 13a of the unlocking piece 13, which rotates together with the manually driven input shaft 2, push the rollers 11 located rearward in the rotational direction of the manually driven input shaft 2 (these rollers are hereinafter referred to as the “rotationally rearward rollers 11”), against the elastic forces of the coil springs 12, into the wide portions of the wedge-shaped spaces 15, so that the rotationally rearward rollers 11 are disengaged from the outer ring 10 and the inner ring 8, and thus the outer ring 10 and the inner ring 8 are unlocked from each other. Thereafter, when, as illustrated in FIG. 3B, the manually driven input shaft 2 further rotates, and the engagement portion 2a of the input shaft 2 pushes the inner surface of the engagement hole 8a of the inner ring 8, the rotationally driving force of the manually driven input shaft 2 is transmitted to the inner ring 8, thereby rotating the inner ring 8 and the output shaft 3 (at this time, since the rotationally forward rollers 11 move, relative to the wedge-shaped spaces 15, to the wide portions of the wedge-shaped spaces 15, the rotationally forward rollers 11 remain out of engagement with the outer ring 10 and the inner ring 8).

The mechanism is now described that prevents the rotation of the outer ring 10 when a rotationally driving force is applied to the manually driven input shaft 2. Assume now that (when the pillars 13a of the unlocking piece 13, which is rotationally fixed to the manually driven input shaft 2, push the rotationally rearward rollers 11): Y is the rotation torque necessary to rotate the electrically driven input gear 1 by rotating the inner and outer rings 8 and 10 together with the rotationally rearward rollers 11 (with the rotationally rearward rollers 11 engaging the inner and outer rings 8 and 10); and Z is the rotation torque necessary to rotate the output shaft 3 by pushing only the rotationally rearward rollers 11 toward the wide portions of the wedge-shaped spaces 15 against the elastic forces of the coil springs 12 and the frictional forces between the rotationally rearward rollers 11 and the inner and outer rings 8 and 10. Then, since the speed reducer 5, in which there is torque loss, is coupled to the input side of the electrically driven input gear 1, the relation Y>Z is satisfied. Therefore, when a rotationally driving force is applied to the manually driven input shaft 2, neither of the outer ring 10 and the electrically driven input gear 1 rotates. Also, by moderately decreasing the elastic forces of the coil springs 12, it is possible to more reliably ensure the relation Y>Z.

This driving force transmission mechanism enables the outer shaft 3 to be rotationally driven by both the electrically driven input gear 1 and the manually driven input shaft 2. Also, since, when a rotationally driving force is applied to the manually driven input shaft 2 so as to rotate the output shaft 3, the electrically driven input gear 1 never rotates together, it is possible to operate the manually driven input shaft 2 with a light force.

Also, because the means for preventing the electrically driven input gear 1 from rotating together with the manually driven shaft 2 when the latter is manually rotated, comprises mounting, on the input side of the electrically driven input shaft 1, a speed reducer 5 having no self-locking function, thereby achieving the above-described relation Y>Z, i.e., making “the rotation torque (Y) necessary to rotate the electrically driven input gear 1 through the input switching clutch 4 from the manually driven input shaft 2” larger than “the rotation torque (Z) necessary to rotate the output shaft 3 through the input switching clutch 4 from the manually driven input shaft 2”, the driving force transmission mechanism according to the present invention can be designed relatively freely, and the entire structure thereof is simple, compared to a driving force transmission mechanism including, on the input side of the electrically driven input gear 1, a reverse input blocking mechanism having a complicated structure.

The means for achieving the above-described torque magnitude relation (Y>Z) is not limited to the structure of the first embodiment, in which a speed reducer 5 is mounted on the input side of the electrically driven input gear 1.

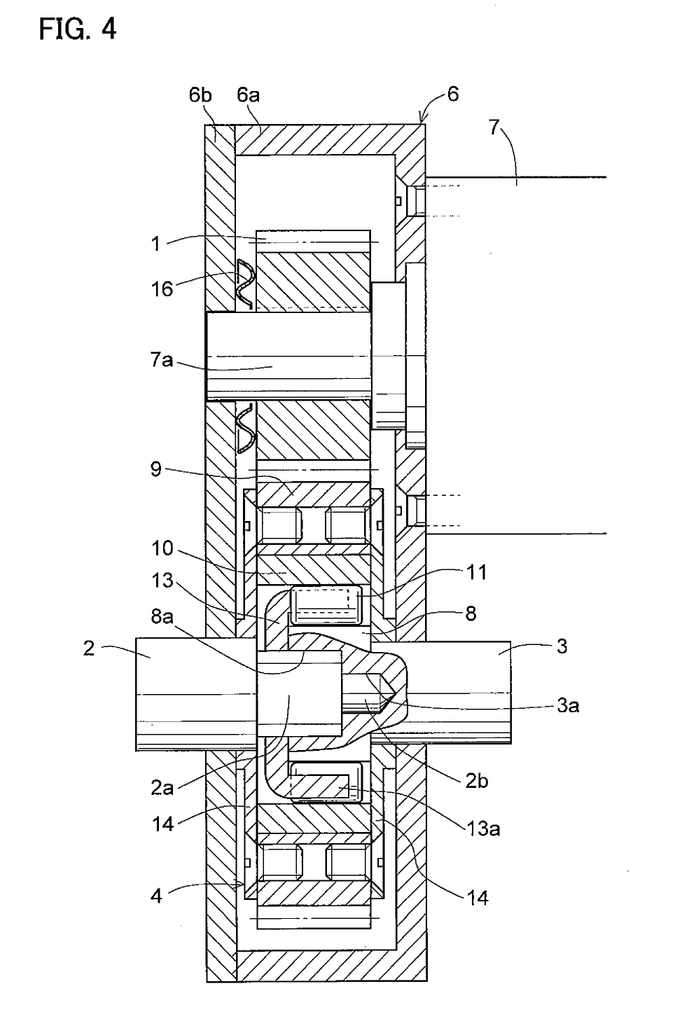

For example, in the second embodiment of FIG. 4, the motor 7 is fixed to the outer side surface of the housing 6 while omitting the speed reducer 5 of the first embodiment; the main shaft 7a of the motor 7 is inserted in, and rotatably supported by, the housing 6; and the electrically driven input gear 1 is fixedly keyed to the outer periphery of the main shaft 7a. Also, a wave washer 16 as an elastic member is mounted, while elastically deformed, between one end surface of the electrically driven input gear 1 and the inner surface of the housing 6 opposed to the one end surface of the input gear 1 to apply a braking force to the electrically driven input gear 1, thereby achieving the relation Y>Z.

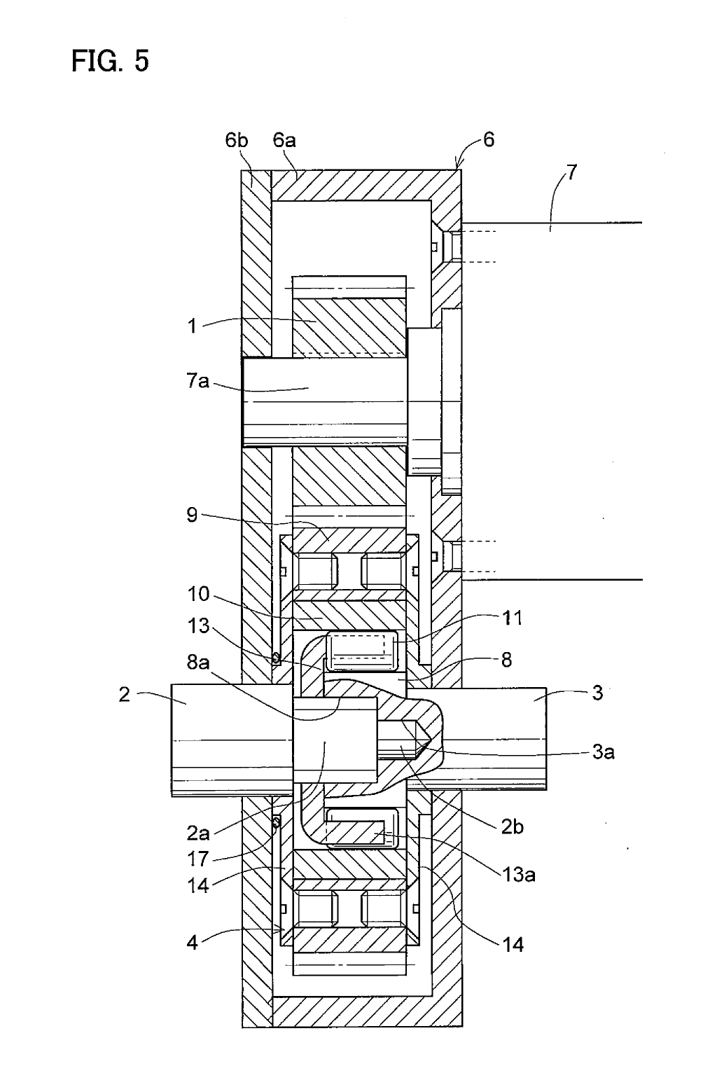

In the third embodiment of FIG. 5, instead of the wave washer 16 of the second embodiment, an O-ring 17 as an elastic member is mounted, while elastically deformed, between one of the side plates 14 fixed to one end surface of the intermediate gear 9 of the input switching clutch 4 and the inner surface of the housing 6 opposed to the one side plate 14 to apply a braking force through the one side plate 14 to the intermediate gear 9 and the outer ring 10, which is rotationally fixed to the intermediate gear 9, thereby achieving the relation Y>Z.

In each of the second and third embodiments, the elastic member for applying a braking force to the electrically drive input gear 1 or the outer ring 10 of the input switching clutch 4 is not limited to a wave washer or an O-ring, and may be, for example, a coil spring.

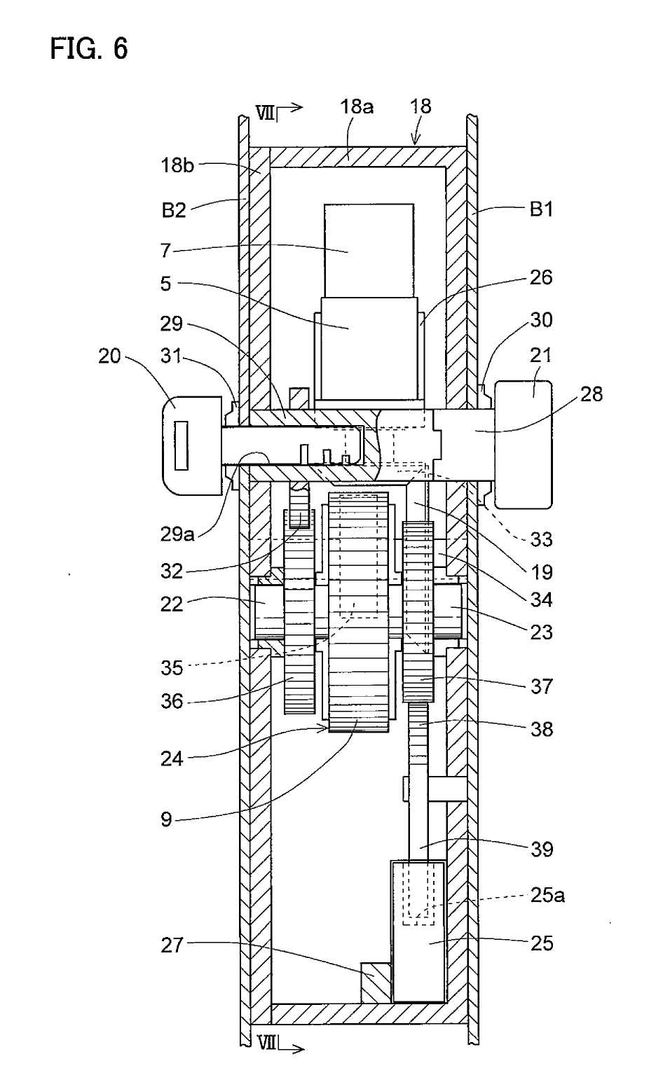

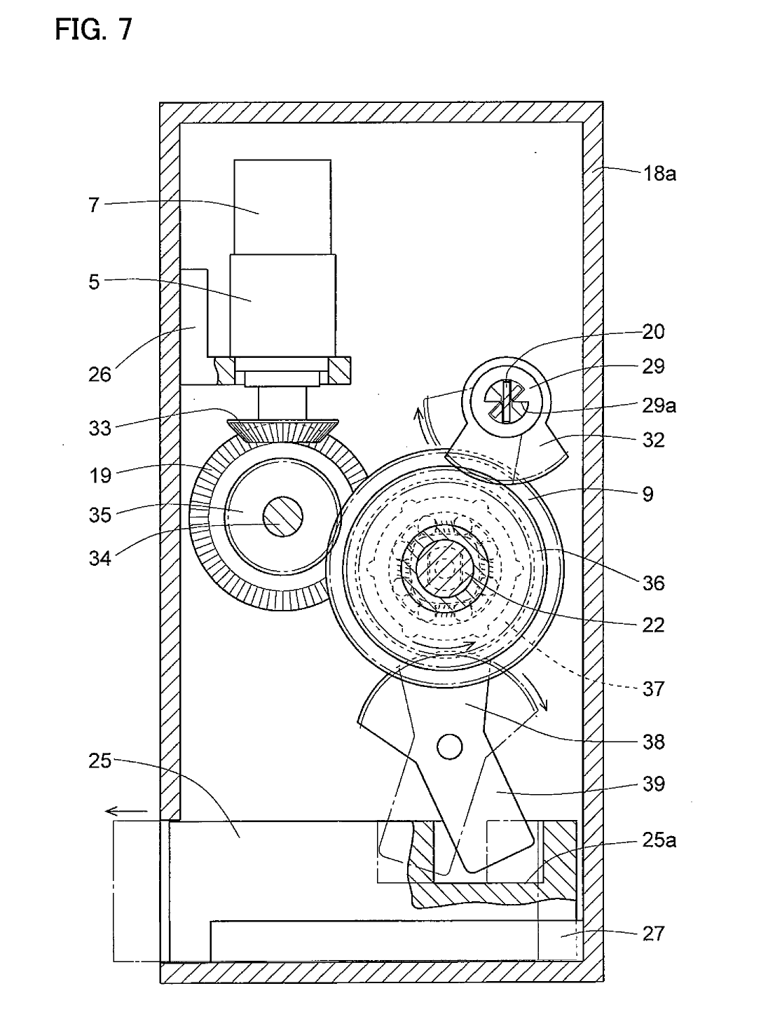

FIGS. 6 and 7 illustrate an electric lock in which a driving force transmission mechanism similar to and slightly modified from that of the first embodiment is mounted. Some of the elements of the modified driving force transmission mechanism identical in function to those of the driving force transmission mechanism of the first embodiment are denoted by the same reference numerals, and their description is omitted.

This electric lock includes, within a lock case 18 corresponding to the housing 6 of the first embodiment, a motor assembly comprising a speed reducer 5 and a motor 7; an electrically driven input gear (first input member) 19 configured to be rotationally driven by the electric driving force of the motor 7; a manually driven input shaft (second input member) 22 configured to be rotationally driven by a manual input from a key 20 or a thumb turn 21; an output shaft (output member) 23 arranged coaxially with the manually driven input shaft 22; an input switching clutch 24 configured to selectively transmit, to the output shaft 23, either one of the driving force electrically applied to the electrically driven input gear 19, and the driving force manually applied to the manually driven input shaft 22; and a dead bolt 25 configured to protrude and retract when the output shaft 23 rotates. Thus, this electric lock can be locked and unlocked both electrically and manually. The input switching clutch 24 is identical in basic structure and operation to the input switching clutch 4 of the first embodiment.

The lock case 18 is fixedly inserted between a pair of plate members B1 and B2 defining the inner surface and the outer surface of an entrance door, respectively, and comprises a rectangular box portion 18a having an open side, and a lid portion 18b closing the open side of the box portion 18a. A bracket 26 supporting the speed reducer 5, and a guiding member 27 for guiding the dead bolt 25 in the protruding/retracting direction are disposed on the inner surface of the box portion 18a.

A thumb turn shaft 28 integral with the thumb turn 21 extends through the box portion 18a of the lock case 18 and the plate member B1, which defines the inner surface of the door. The thumb turn shaft 28 is coupled to a key shaft 29 into which the distal end portion of the key 20 can be inserted such that rotation can be transmitted between the thumb turn shaft 28 and the key shaft 29. The key shaft 29 is rotatably supported by the lid portion 18b of the lock case 18. A thumb turn seat 30 is mounted to the surface of the plate member B1, i.e., the inner surface of the door to rotatably support the thumb turn shaft 28. A key seat 31 is mounted to the surface of the plate member B2, i.e., the outer surface of the door, such that the distal end portion of the key 20 can be inserted into the key shaft 29 through the key seat 31 and the plate member B2.

The key shaft 29 has a key hole 29a into which the distal end portion of the key 20 can inserted, and which has two radially opposed recesses each having a fan-shaped cross section. When the key 20 is inserted into the key hole 29a, and is rotated in a predetermined direction in order to lock or unlock the electric lock, the key shaft 29 is also rotated in the same direction as the key 20. A first partial gear 32 having teeth on its fan-shaped outer periphery is fixedly fitted to the longitudinally central portion of the key shaft 29.

The electrically driven input gear 19 comprises a bevel gear which is in mesh with a bevel gear 33 mounted on the output side of the speed reducer 5, and which is fixedly fitted to an electrically driven input shaft 34 inserted through the center of the bevel/input gear 19. Both end portions of the electrically driven input shaft 34 are rotatably supported by the lock case 18. A pinion 35 is fixedly fitted on the outer periphery of the electrically driven input shaft 34 at a position axially closer to its axial center than is the electrically driven input gear 19. The pinion 35 is in mesh with the intermediate gear 9 of the input switching clutch 24.

The manually driven input shaft 22 and the output shaft 23, which are identical in structure to the manually driven input shaft 2 and the output shaft 3 of the first embodiment, are supported at their outer end portions by the lock case 18, and are coupled together in the same manner as the input and output shafts 2 and 3 of the first embodiment are coupled together. A manually driven input gear 36 is fixedly fitted to the outer periphery of the manually driven input shaft 22, and is in mesh with the first partial gear 32 on the outer periphery of the key shaft 29. An output gear 37 is fixedly fitted to the outer periphery of the output shaft 23, and is in mesh with a second partial gear 38 rotatably supported between the output gear 37 and the dead bolt 25. The second partial gear 38 comprises a fan-shaped portion formed with teeth. A rectangular plate-shaped engagement piece 39 is integrally connected to the fan-shaped second partial gear 38 on the opposite side of the common rotation center from the second partial gear 38. A portion of the engagement piece 39 is inserted in a recess 25a formed in the dead bolt 25.

The recess 25a is formed in the rear end portion of the dead bolt 25 in the protruding direction of the dead bolt 25. The rotation (pivoting motion) of the engagement piece 39, which is inserted in the recess 25a, causes the dead bolt 25 to move in the protruding or retracting direction, while guided by the inner surface of the box portion 18a of the lock case 18 and the guiding member 27, until the distal end portion of the dead bolt 25 protrudes beyond or retracts into the lock case 18.

It is now described how the above-described electric lock operates. When the motor 7 is activated, the rotationally driving force of the motor 7 is applied to the electrically driven input gear 19 through the speed reducer 5. The rotationally driving force is then transmitted to the outer ring 10 of the input switching clutch 24 through the electrically driven input shaft 34, the pinion 35 and the intermediate gear 9, and transmitted to the output shaft 23 and the output gear 37 by the action of the input switching clutch 24 as in the first embodiment. This causes the second partial gear 38, which is in mesh with the output put gear 37, to rotate together with the engagement piece 39, which in turn causes the distal end portion of the dead bolt 25 to protrude beyond or retract into the lock case 18, thereby locking or unlocking the electric lock.

At this time, since the manually driven input shaft 22 also rotates together due to the action of the input switching clutch 24 as in the first embodiment, the rotation of the electrically driven input gear 22 is transmitted through the manually driven input gear 36 to the first partial gear 32 and the key shaft 29. When the key shaft 29 rotates, the thumb turn shaft 28, which is coupled to the key shaft 29, also rotates together. Therefore, even when the electric lock is locked or unlocked electrically, it is possible to confirm the locked or unlocked state of the electric lock by visually checking the thumb turn 21 from inside of the entrance door.

On the other hand, when the key 20 is inserted through the key seat 31 into the key shaft 29, and turned in a predetermined direction, the rotationally driving force of the key 20 is applied to the manually driven input shaft 22 through the key shaft 29, the first partial gear 32, and the manually driven input gear 36, and is transmitted to the output shaft 23 by the action of the input switching clutch 24 as in the first embodiment. The rotation of the output shaft 23 moves the dead bolt 25 in the protruding or retracting direction, thereby locking or unlocking the electric lock, in the same manner as when the motor 7 is activated. When the thumb turn 21 is turned in a predetermined direction, too, the electric lock is locked or unlocked in the same manner as when the key 20 is turned.

When the key 20 or the thumb turn 21 is turned as described above, since, as in the first embodiment, the rotation torque necessary to rotate the electrically driven input gear 19 through the input switching clutch 24 from the manually driven input shaft 22 is set to be larger than the rotation torque necessary to rotate the output shaft 23 through the input switching clutch 24 from the manually driven input shaft 22, the members of the electric lock on its electrical driving force input side, such as the electrically driven input gear 19, never rotate together, and thus the key 20 or the thumb turn 21 can be operated with a light force.

Also, since only a speed reducer 5 having no self-locking function is mounted on the input side of the electrically driven input gear 19, the electric lock of the present invention can be designed relatively freely, and the entire structure thereof is simple, compared to conventional ones including a reverse input blocking mechanism having a complicated structure.

The driving force transmission mechanism of the present invention can be widely used not only in an electric lock as described above but also in other machines or devices capable of being activated both electrically and manually.

### DESCRIPTION OF REFERENCE NUMERALS

1, 19: electrically driven input gear (first input member)
2, 22: manually driven input shaft (second input member)
3, 23: output shaft (output member)
4, 24: input switching clutch
5: speed reducer
6: housing (fixed member)
7: motor
8: inner ring
8b: cam surface
9: intermediate gear
10: outer ring
11: roller (locking engagement element)
12: coil spring
13: unlocking piece
13a: pillar
15: wedge-shaped space
16: wave washer (elastic member)
17: O-ring (elastic member)
18: lock case
20: key
21: thumb turn
25: dead bolt
28: thumb turn shaft
29: key shaft
32: first partial gear
34: electrically driven input shaft
35: pinion
36: manually driven input gear
37: output shaft
38: second partial gear assembly
39: engagement piece

1. A driving force transmission mechanism comprising:
a first input member;
a second input member;
an output member; and
an input switching clutch configured to selectively transmit, to the output member, either one of a first rotationally driving force applied to the first input member and a second rotationally driving force applied to the second input member,
wherein rotation torque necessary to rotate the first input member through the input switching clutch from the second input member is set to be larger than rotation torque necessary to rotate the output member through the input switching clutch from the second input member.

2. The driving force transmission mechanism according to claim 1, further comprising, on an input side of the first input member, a speed reducer having no self-locking function.

3. The driving force transmission mechanism according to claim 1, further comprising a braking force applying mechanism for applying a braking force to a braking force receiving member comprising the first input member.

4. The driving force transmission mechanism according to claim 1, wherein the input switching clutch comprises:
an outer ring having a cylindrical inner peripheral surface, and coupled to the first input member such that rotation can be transmitted between the outer ring and the first input member;
an inner ring disposed radially inwardly of the outer ring, and configured to rotate about a center axis of the second input member together with the output member, the inner ring having, on an outer peripheral surface of the inner ring, a plurality of cam surfaces arranged circumferentially such that a wedge-shaped space is defined between the inner peripheral cylindrical surface of the outer ring and each of the cam surfaces of the inner ring, the wedge-shaped space gradually narrowing toward respective circumferential ends thereof to define narrow portions at the respective circumferential ends;
locking engagement elements and a spring disposed in each of the wedge-shaped spaces such that the spring wedges the locking engagement elements into the respective narrow portions of the wedge-shaped space;
an unlocking piece having pillars, and coupled to the second input member such that rotation can be transmitted between the unlocking piece and the second input member, each pair of the pillars being inserted, respectively, in the circumferential ends of the wedge-shaped space, or the pillars being each inserted between a corresponding adjacent pair of the wedge-shaped spaces; and
a torque transmission mechanism disposed between the second input member and the inner ring, and configured to transmit rotation of the second input member to the inner ring with a slight angular delay,
wherein the input switching clutch is configured such that, when the first rotationally driving force is applied to the first input member, the outer ring and the inner ring are locked together through one of the locking engagement elements in each of the wedge-shaped spaces, thereby transmitting the first rotationally driving force to the inner race and the output member; and such that, when the second rotationally driving force is applied to the second input member, and the second input member rotates, the outer ring and the inner ring are unlocked from each other, thereby transmitting the second rotationally driving force to the inner ring and the output member, and
wherein the driving force transmission mechanism further comprises a braking force applying mechanism for applying a braking force to a braking force receiving member comprising the outer ring of the input switching clutch.

5. The driving force transmission mechanism according to claim 3, wherein the braking force applying mechanism comprises an elastic member mounted, while elastically deformed, between a fixed member and the braking force receiving member.

6. An electric lock comprising:
the driving force transmission mechanism according to claim 1;
a motor configured to rotationally drive the first input member;
one of a key and a thumb turn configured to rotationally drive the second input member when a manual driving force is applied to the one of the key and the thumb turn; and
a dead bolt configured to move in one of a protruding direction and a retracting direction when the output member rotates.

7. The driving force transmission mechanism according to claim 4, wherein the braking force applying mechanism comprises an elastic member mounted, while elastically deformed, between a fixed member and the braking force receiving member.

8. An electric lock comprising:
the driving force transmission mechanism according to claim 2;
a motor configured to rotationally drive the first input member;
one of a key and a thumb turn configured to rotationally drive the second input member when a manual driving force is applied to the one of the key and the thumb turn; and
a dead bolt configured to move in one of a protruding direction and a retracting direction when the output member rotates.

9. An electric lock comprising:
the driving force transmission mechanism according to claim 3;
a motor configured to rotationally drive the first input member;
one of a key and a thumb turn configured to rotationally drive the second input member when a manual driving force is applied to the one of the key and the thumb turn; and
a dead bolt configured to move in one of a protruding direction and a retracting direction when the output member rotates.

10. An electric lock comprising:
the driving force transmission mechanism according to claim 4;
a motor configured to rotationally drive the first input member;
one of a key and a thumb turn configured to rotationally drive the second input member when a manual driving force is applied to the one of the key and the thumb turn; and
a dead bolt configured to move in one of a protruding direction and a retracting direction when the output member rotates.

11. An electric lock comprising:
the driving force transmission mechanism according to claim 5;
a motor configured to rotationally drive the first input member;
one of a key and a thumb turn configured to rotationally drive the second input member when a manual driving force is applied to the one of the key and the thumb turn; and
a dead bolt configured to move in one of a protruding direction and a retracting direction when the output member rotates.

12. An electric lock comprising:
the driving force transmission mechanism according to claim 7;
a motor configured to rotationally drive the first input member;
one of a key and a thumb turn configured to rotationally drive the second input member when a manual driving force is applied to the one of the key and the thumb turn; and
a dead bolt configured to move in one of a protruding direction and a retracting direction when the output member rotates.
